(19) United States
(12) Patent Application Publication
(10) Pub. No.: US 2008/0264374 A1
(43) Pub. Date: Oct. 30, 2008

(54) Fail-safe starter control system

(75) Inventor: James Wallace Harris, Galveston, IN (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/797,021

(22) Filed: Apr. 30, 2007

(51) Int. Cl. F02N 11/00

(52) U.S. Cl. 123/179.3

(57) ABSTRACT

A starter control system for a combustion engine is disclosed. The starter control system may have a first starter and a second starter each coupled to independently initiate cranking of the combustion engine, and a sensor to generate a first signal indicative of an operational condition. The starter control system may further include a controller communicatively coupled to the first and second starters and the sensor. The controller may be configured to determine a status of the first starter and a status of the second starter based on the first signal, and command one of the first and second starters to crank the combustion engine to an ignition speed based the status of the first starter and the status of the second starter in response to a request to start the engine.

### TECHNICAL FIELD

The present disclosure relates generally to the control of starter motors, and more particularly, to a fail-safe starter control strategy.

### BACKGROUND

Machines such as, for example, on and off highway vehicles, excavation machines, construction equipment, marine vessels, generator sets, and/or other types of machines often include one or more heat engines to propel and/or power other operations of the machine. These machines typically include one or more electrically-, hydraulically-, and/or pneumatically-driven starter motors coupled to crank the engine to a rotational speed at which ignition and subsequent combustion can occur. Upon successful ignition, the starter motor is disengaged.

Due to the sudden, violent operation of the starter motor and the large amount of torque required to crank an engine, the starter motor tends to draw large current from an on-board battery during operation. Typically, the battery is designed to provide only three or four engine cranking events before depleting the energy stored therein. Thus, if the engine fails to start after several attempts, the charge present in the battery may be insufficient to start the engine. Further, starter motors also tend to be susceptible to wear and failure, and the effects of cold temperatures, intermittent usage, and other environmental factors only exacerbate such problems. Since engine operation depends upon a properly-functioning starter motor, there is a need to provide reliable starter motor control.

One starter motor control strategy is described in U.S. Pat. No. 6,769,389 (the '389 patent) issued to Tamai et al. on Aug. 3, 2004. The '389 patent discloses a control system having a low voltage starter motor coupled to a low voltage battery pack, and a motor/generator coupled to a high-voltage battery pack. A control unit sends an electrical signal to the low-voltage starter motor to begin turning the engine up to an initial, predetermined rotational speed. Once this speed has been reached, the control unit sends an electric signal to the motor/generator, which begins to drive the engine in tandem with the low-voltage starter motor to a second predetermined rotational speed greater than the first rotational speed. Once the second rotational speed has been achieved, the control unit sends a signal to the low voltage starter motor to stop turning the engine. Subsequently, the control unit signals the motor/generator to turn the engine to a final predetermined speed, at which ignition takes place. During operation, the control unit monitors the voltage levels of the low-voltage battery pack and the high-voltage battery pack. If, while turning the engine to the second predetermined rotational speed, the control unit senses that the voltage level of the low-voltage battery pack falls below a certain threshold, the control unit signals the low-voltage starter motor to stop turning the engine, leaving the motor/generator alone turning the engine.

Although the control system of the '389 patent may facilitate starting an engine in low voltage situations by providing a tandem starter arrangement, it may be unreliable for various reasons. For example, if the low-voltage start motor fails electrically and/or mechanically and cannot turn the engine, the generator/motor does not have a capacity sufficient to independently crank the engine to ignition speed, and cannot alone initiate cranking of the engine. In fact, the '389 patent indicates that, in such a situation, the engine must be jump-started. Second, since both the low voltage starter motor and the motor/generator are used in tandem during a typical engine start-up, the component life of both starters may be compromised by continuous usage. Further, the control system of the '389 patent cannot detect failure of the starter motor, but only a low voltage situation. As such, there is no true backup starter system in place in case this tandem arrangement fails.

The present disclosure is directed towards overcoming one or more of the problems set forth above.

### SUMMARY OF THE INVENTION

One aspect of the disclosure is directed to a starter control system for a combustion engine. The starter control system may include a first starter and a second starter, each coupled to independently initiate cranking of the combustion engine, and a sensor to generate a first signal indicative of an operational condition. The starter control system may further include a controller communicatively coupled to the first and second starters and the sensor. The controller may be determine a status of the first starter and a status of the second starter based on the first signal, and command one of the first and second starters to crank the combustion engine to an ignition speed based the status of the first starter and the status of the second starter in response to a request to start the engine.

Another aspect of the disclosure is directed to another starter control system for a combustion engine. This starter control system may include a first starter and a second starter each coupled to independently initiate cranking of the combustion engine, and a controller communicatively coupled to the first and second starters. The controller may be configured to receive a request signal indicative of an operator's desire to start the combustion engine, and a selection signal indicative of an operator desired one of the first and second starters to start the combustion engine. The controller may be further configured to command one of the first and second starters to crank the combustion engine to an ignition speed based on the selection signal and in response to the request signal.

### BRIEF DESCRIPTION OF THE DRAWINGS

FIG. 1 is a schematic representation of an exemplary disclosed starter control system; and

FIGS. 2A and 2B show flowcharts representing exemplary disclosed operation performed by of the starter control system of FIG. 1.

### DETAILED DESCRIPTION

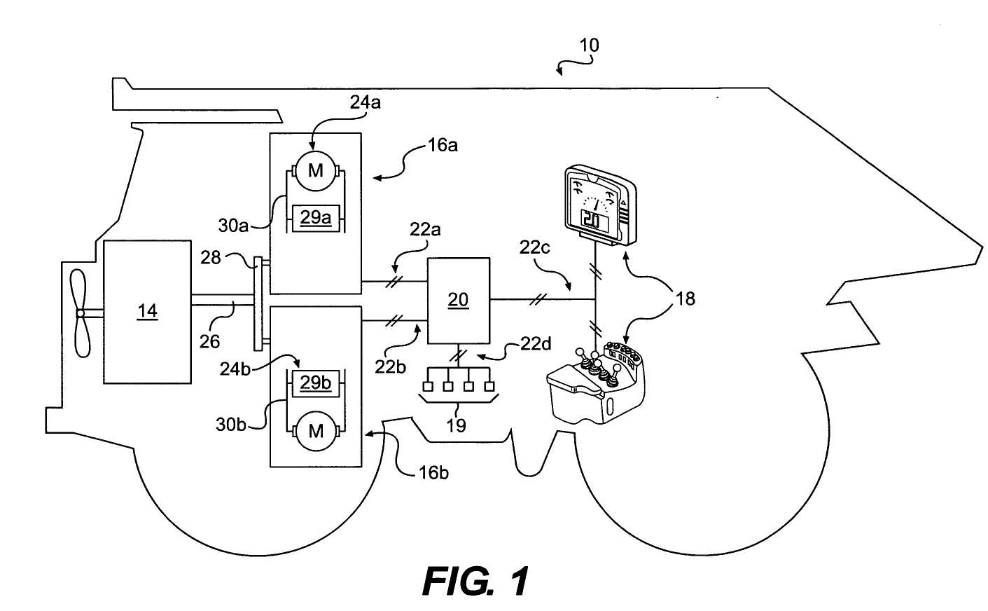

FIG. 1 shows a machine 10 having an exemplary starter control system 12. Machine 10 may be a fixed or mobile machine that performs some type of operation associated with an industry such as mining, construction, farming, transportation, or another known industry. For example, machine 10 may be an earth moving machine, a rock hammer, an electric power generator set, a petroleum compressor, a marine propulsion system, a rock crusher, a locomotive, a pump, an on- or off-highway vehicle, or any other suitable operation-performing machine. Machine 10 may include an internal combustion engine 14, such as a diesel engine, a gasoline engine, a gaseous fuel-powered engine, or another suitable source to power operations of and/or to propel machine 10. For example, engine 14 may be used to drive machines and/or equipment such as an electric power generator set, a rock crusher, a petroleum compressor, or a marine propulsion system. Starter control system 12 may include a first starter 16a, a second starter 16b, an operator interface 18, and one or more sensors 19 communicatively coupled to a controller 20 by way of a plurality of signal links 22a, 22b, 22c, and 22d, respectively.

First and second starters 16a and 16b may each include one or more motors 24a and 24b individually or collectively coupled to crank engine 14 by way of a crankshaft 26. For example, an output shaft (not shown) of each of motors 24a and 24b may be connected to provide rotational power through a coupling means 28 to drive crankshaft 26. Starters 16a and 16b may each have a dedicated power source 29a and 29b connected to drive motors 24a and 24b by way of circuits 30a and 30b, respectively. Although each starter 16a, 16b is shown to include a single motor 24a, 24b, it is to be appreciated that a greater number of motors 24a and 24b may be included with each starter 16a and 16b to provide a desired degree of cranking capacity (e.g., torque), reliability, and/or redundancy. Similarly, each starter 16a and 16b may include a greater number of power sources 29a and 29b, if desired. That is, each of starters 16a and 16b may comprise a starter package having one or more components and/or systems arranged to crank engine 14. Each of starters 16a and 16b may have a capacity (e.g., torque and/or power output) sufficient to independently initiate cranking of engine 14, and to crank engine to an ignition speed. Further, it is contemplated that each of motors 24a and 24b may alone have a capacity sufficient to independently initiate cranking of engine 14, and to crank engine to an ignition speed.

In one embodiment, motors 24a and 24b may each embody a DC electric motor that may be energized upon receiving an appropriate engine crank command signal. Power sources 29a and 29b may embody one or more batteries configured to provide electrical power to terminals of motors 24a and 24b by way of circuits 30a and 30b during an engine cranking event. For example, power sources 29a and 29b may each comprise a battery pack or assembly having a plurality of individual batters connected in parallel or in series to provide a DC electrical current to one or more solenoids (not shown) associated with each of motors 24a and 24b. The current may be stored by the solenoid(s) until an engine cranking event is commanded by controller 20. Upon receiving an engine crank command signal, the solenoid(s) may discharge the stored electrical current into electrical circuits 30a and 30b, which may drive respective motors 24a and 24b and crank engine 14. It is to be appreciated, however, that the batteries may be replaced with another suitable electrical power source, such as, for example, an AC power source and a rectifier, if desired

Motors 24a and 24b may alternatively comprise motor/generators. As such, during engine operation (i.e., after engine 14 has been started), starters 16a and 16b may remain engaged with engine 14 and generate electricity that can be directed to charge the respective batteries and/or power other systems and/or components of machine 10 by way of an alternator (not shown), if desired. In one example, if one of motors 24a and 24b fails, the remaining functional motor may be used to charge the battery(ies) of its respective starter 16a, 16b, as well as the battery(ies) associated with the failed motor. Further, each motor 24a and 24b may selectively draw power from the battery(ies) of either or both starters 16a and 16b, if necessary. Alternatively or additionally, motors 24a and 24b may be driven to add supplemental power to engine 14 during operation, if desired.

In another embodiment, motors 24a and 24b may each embody a variable- or fixed-displacement pneumatic or hydraulic motor. In this embodiment, power sources 29a and 29b may comprise fluid sources such as, for example, a compressed air source and a hydraulic accumulator, respectively. Circuits 30a and 30b may comprise fluid ducts. The sources may release a flow of compressed fluid into ducts 30a and 30b upon receipt of an appropriate crank request signal from controller 20. The compressed fluid may rotationally drive each of motors 24a and 24b to crank engine 14. It is to be appreciated that another suitable driving arrangement known in the art may be used alternatively or additionally, if desired.

Coupling means 28 may embody, for example, an engine flywheel ring gear and an overrunning clutch mechanism having a shifting pinion to engage the ring gear upon initiation of an engine start event. Alternatively, coupling means 28 may comprise a belt-drive arrangement. It is to be appreciated, however, that the output shafts of each of motors 24a and 24b may be otherwise directly or indirectly connected to provide rotational power to crankshaft 26 in a suitable manner.

Operator interface 18 may include a monitor, a touch-screen, a portable hand-held device, a keypad, a control panel, a keyboard, an off-board command and control system, and/or other suitable input devices. Interface 18 may receive input from a machine operator and generate corresponding command signals in response to the input, which may be communicated to controller 20 for processing and/or execution. In one aspect, interface 18 may include a starter mode selection device such as, for example, a knob, a dial, a selector switch, one or more buttons, etc., allowing the operator to select an automatic starter mode and a manual starter mode. In response to an operator's selection of a desired starter mode, interface 18 may communicate a corresponding selection signal to controller 20. Operation of the starter modes will be further discussed below.

Interface 18 may also include means for receiving a machine operator's request to start engine 14 and for generating a corresponding start request signal. The means for receiving and generating may include a switch configured to receive a coded key having magnetic information thereon, a memory chip embedded thereon, a radio-frequency identification circuit (RFID) thereon, a keypad allowing the code to be manually entered by an operator, a data port allowing direct communication with a service tool or a computer having the code, an antenna allowing reception of the code from a remote location, a scanner configured to read coded indicia, or any other configuration that can receive the code and generate a signal indicative of the code. Interface 18 may also display data relating to machine and/or starter status in response to signals from controller 20.

Sensors 19 may include any means disposed about machine 10 to gather, report, and/or otherwise communicate data relating to an operational condition of machine 10, engine 14, starters 16a and 16b, power sources 19a and 19b, and motors 24a and 24b, respectively. For example, sensors 19 may detect and report engine speed (RPM), battery voltages (e.g., low, medium, high, etc.), air and/or hydraulic supply characteristics (e.g., pressures), temperatures and/or rotational speeds of motors 24a and 24b, engagement/disengagement of coupling means 28, and/or other operational parameters and/or conditions of interest. In a scenario where engine 14 is used to drive equipment, such as, for example, a petroleum compressor or an electric generator set, sensors 19 may also gather data relating to an operational condition of the driven equipment (e.g., an output power, speed, pressure, fluid displacement rate, etc.). Sensors 19 may provide signals to controller 20 indicative of values of the sensed operational parameters (e.g., 95 RPM, 11.5 VDC, 2.4 atm, 150° C., etc.) by way of signal links 22d.

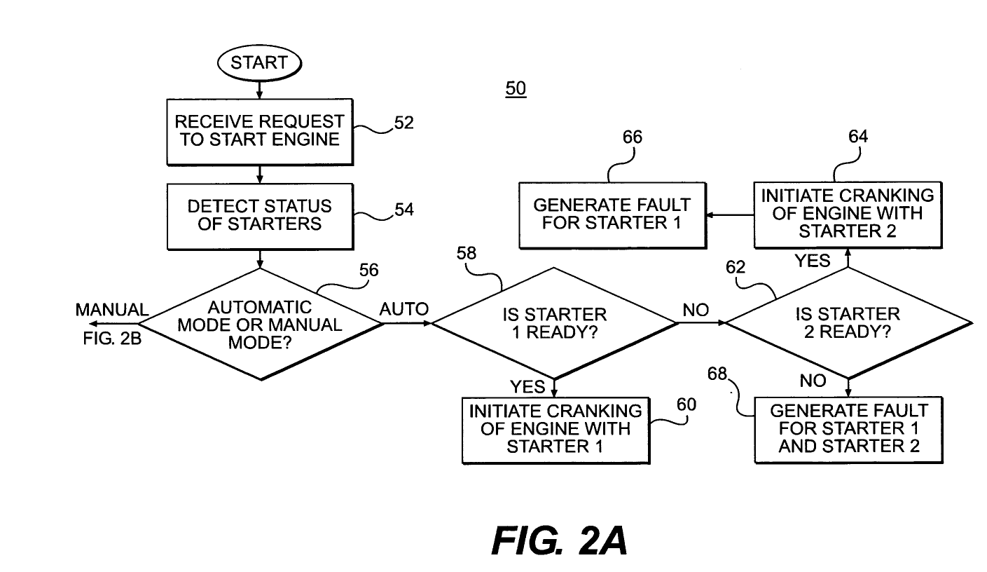

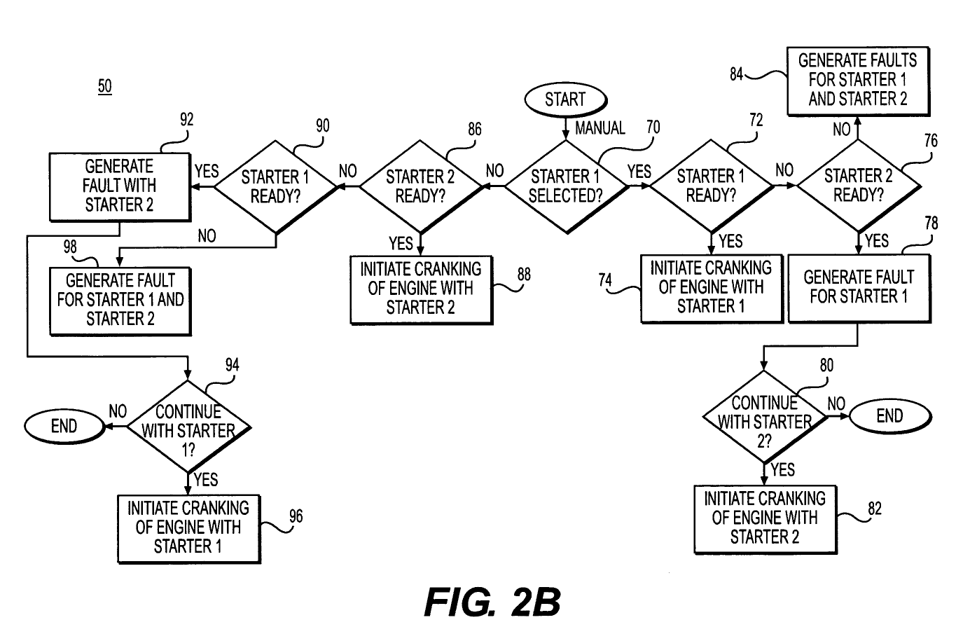

Operation of starter control system 12 may be regulated by controller 20. Controller 20 may include, for example, an electronic control module (ECM), or another processor capable of executing, and/or or outputting command signals in response to received and/or stored data to affect, among other things, the starter control algorithm 50 illustrated in FIGS. 2A and 2B. Controller 20 may include computer-readable storage, such as read-only memories (ROM), random-access memories (RAM), and/or flash memory; one or more secondary storage device, such as a tape-drive and/or magnetic disk drive; one or more microprocessor (CPU), and/or any other components for running an application and processing data. The microprocessor(s) may comprise any suitable combination of commercially-available or specially-constructed microprocessors for controlling system operations. As such, controller 20 may include instructions and/or data stored as hardware, software, and/or firmware within the memory, secondary storage device(s), and/or microprocessor(s). Alternatively or additionally, controller 20 may include and/or be associated with various other suitably arranged hardware and/or software components. For example, controller 20 may include power supply circuitry, signal conditioning circuitry, solenoid driver circuitry, amplifier circuitry, timing circuitry, filtering circuitry, switches, and/or other types of circuitry, if desired.

Controller 20 may include one or more data storage structures in the computer-readable medium containing predetermined data to facilitate starter control determinations in connection with algorithm 50 of FIG. 2. The data storage structures may include, for example, arrays matrices, tables, variable classes, etc. The predetermined data may be based on known machine and/or starter control system performance specifications, such as those of engine 14, motors 24a and 24b, power sources 29a and 29b, and/or other components or systems of machine 10. The predetermined data may be derived from performance test results, engineering knowledge, and/or other resources. For example, the data storage may include an appropriate engine speed at which ignition should take place (e.g., 150 RPM), lookup tables defining the amounts of electrical current, fluid displacement rates, and/or pressures required to provide an appropriate torque to crank engine to the ignition speed for a variety of power source capacities (e.g., 12 VDC, 12.8 atm, 50 litres/sec, etc.). The tables may map these required amounts to signal parameters, such as, for example, pulse widths, duty cycles, gains, frequencies, coefficients, and/or other parameters that can be used to define signals.

During operation, controller 20 may receive the signals provided by sensors 19 indicative of values of the sensed operational parameters and determine a status of each of starters 16a and 16b by comparing the sensed values to predetermined data in the computer readable storage. In one aspect, the status of each of starters 1 6a and 1 6b may include a predetermined state value, such as, for example, “ready”, “unavailable”, “failed”, and/or other suitable states. The “ready” state may indicate to controller 20 that the respective starter 16a, 16b is prepared to initiate cranking of engine 14. That is, in the “ready” state the starter 16a, 16b may be prepared to execute a crank request signal. The “unavailable” state may indicate to controller 20 that conditions are incorrect for use of the respective starter 16a, 16b. For example, the “unavailable” state may be conveyed when the corresponding starter 16a, 16b, has a low battery voltage, low air pressure, low hydraulic pressure, a high generator/motor temperature, and/or otherwise cannot immediately initiate engine cranking. The “unavailable” state may also indicate that engine 14 and/or other components or systems of machine 10 are operating in a mode incompatible with an engine start event, such as, for example, when an engine rotating interlock is engaged, the current speed of engine 14 is above the ignition speed (e.g., engine 14 is already running), a predetermined period of time has not yet expired since a previous start event, coupling means 28 has not successfully engaged or disengaged, etc. The “failed” state may indicate to controller 20 that the respective starter 16a, 16b, is severely compromised and requires service and/or replacement. For example, a “failed” state may be conveyed upon detection and/or determination by controller 20 that a diagnostic flag has been triggered.

Controller 20 may also receive a signal from operator interface 18 indicating selection of an automatic start mode, or selection of a manual start mode designating a desired one of starters 16a and 16b to initiate cranking of engine 14. Controller 20 may also receive a signal from operator interface 18 indicative of the operator's request to start engine 10 (e.g., turning a key and/or pressing a button). Based on these signals, and the status of starters 16a and 16b, controller 20 may reference and utilize the stored signal parameters to generate an appropriate crank request signal directed to one of starters 16a and 16b. In other words, controller 20 may appropriately generate a crank request signal by amplifying, modulating, filtering or otherwise creating or modifying a signal based on the pulse widths, duty cycles, frequencies, gains, coefficients, etc., retrieved from the tables. It is to be appreciated that the signals referred to herein may include comprise fixed- or variable-frequency, pulse width modulated (PWM) square wave signals, frequency- and/or amplitude-modulated signals, encoded digital signals, or any other types of signals suitable for commanding starters 16a and 16b. Controller 20 may communicate the crank request signal to starters 16a and 16b and/or motors 24a and 24b directly, which may initiate cranking of engine 14, as discussed above.

Signal links 22a-c may include any suitable combination of hardwired and/or wireless non-proprietary links and/or proprietary links known in the art. Further, the communications and signals referred to herein may be executed according to any protocols based on known industry standards, such as, for example, SAE J1587, SAE J1939, RS-232, RP1210, RS-422, RS-485, MODBUS, CAN, SAEJ1587, Bluetooth, 802.11b or g, or any other suitable protocol known in the art. Further, the communications may be facilitated by network architecture, such as, for example, a telephone-based network (such as a PBX or POTS), a satellite-based network, a local area network (LAN), a wide area network (WAN), a dedicated intranet, the Internet, and/or any other suitable network architecture known in the art. Alternatively or additionally, signal links 22a-c may comprise hardwired connections between controller 20 and the various elements of control system 12 to facilitate the transmission of discrete, analog signals without the use of a particular protocol and/or network architecture.

### INDUSTRIAL APPLICABILITY

The disclosed starter control system may be applicable to any engine system that benefits from having backup starter capabilities. Particularly, the disclosed controller may detect a starter's failure and appropriately crank the engine with a functioning starter. Further, since each of the disclosed starters may independently initiate cranking of the engine and then bring the speed of the engine to an ignition speed, without operating in tandem, a backup starter may be available in the event of a failure of one of the starters. The control algorithm of starter control system 12 will now be described.

Referring to FIG. 2A, during operation of machine 10, controller 20 may receive from interface 18 a signal indicating an operator's request to start engine 14 (step 52). Controller 20 may also receive signals from sensors 19 and determine the status of each starters 16a and 16b by analyzing the signals and comparing the signals to values stored in the computer readable storage (step 54). It is noted that controller 20 may also determine the status of a starter 16a, 16b by attempting to crank engine 14 therewith. If engine 14 does not turn, the status thereof may be “unavailable” or “failed”.

Subsequently, controller 20 may determine whether an automatic or manual starter mode has been selected by the operator (e.g., by way of a selector switch or knob provided on interface 18) (step 56). That is, controller may analyze the starter selection signal communicated from interface 18 by way of signal link 22c. Alternatively, controller 20 may independently determine and select an appropriate mode to use (i.e., irrespective of the selection signal), based on the signals provided by sensors 19. When it is determined that an automatic starter mode has been selected, controller 20 may determine if the status of first starter 16a is “ready” (step 58). If the status of first starter 16a is “ready”, controller 20 may initiate cranking of engine 14 with first starter 16a (step 60). That is, controller 20 may communicate an appropriate crank request signal to first starter 16a, which may cause starter 16a to independently crank engine 14 to the ignition speed, as discussed above.

When controller 20 determines that the status first starter is “unavailable” or failed” (e.g., low battery voltage, high generator/motor temperature, etc.) upon completion of step 58, controller 20 may determine if the status of the second starter 16b is “ready” (step 62). If so, controller 20 may initiate cranking of engine 14 with second starter 16b (step 64) and generate a fault and/or alert the machine operator of the failure of first starter 16a (step 66). For example, if controller 20 detects that the status of second first starter 16a is “unavailable,” controller 20 may cause interface 18 to display: “The primary starter is unavailable due to a low battery voltage,” and/or log a fault in a machine operation log. For example, controller 20 may cause interface to display: “The primary starter has failed. Maintenance is required.” It is to be appreciated that the alerts may alternatively or additionally be audible, if desired

When controller 20 determines that the status of second starter 16b is “failed” or “unavailable” upon completion of step 62, controller 20 may generate a fault and/or alert the machine operator with respect to both first starter 16a and second starter 16b (step 68). For example, controller 20 may cause interface 18 to display: “The primary and secondary starters have overheated. Please wait 15 minutes and try again.”

Referring now to FIG. 2B, if controller 20 determines that the machine operator has selected the manual starter mode upon completion of step 56, controller 20 may determine if the operator has selected first starter 16a (step 70). That is, controller 20 may analyze the received selection signal to determine which starter has been selected. If first starter 16a has been selected, controller 20 may determine if the detected status thereof is “ready”, as discussed above (step 72). If so, controller 20 may initiate cranking of engine 14 with first starter 16a, as discussed above (step 74).

When controller 20 determines upon completion of step 72 that the status of first starter 16a is “unavailable” or “failed”, controller 20 may determine if the status of second starter is “ready” (step 76). If so, controller 20 may generate, log, and/or report a fault and/or alert the machine operator with respect to first starter 16a, as discussed above (step 78). Controller 22 may then prompt the machine operator, by way of interface 18, to start engine 14 with second starter 16b instead of first starter 16a (step 80). For example, controller 20 may cause interface to display: “The primary starter is unavailable and/or has failed. Start engine with secondary starter (Yes/No)?” If the operator chooses “Yes” (e.g., pressing a “Yes” button provided on interface 18) during step 80, controller 20 may initiate cranking of engine 14 with second starter 16b, as described above (step 82). If the operator chooses “No” during step 80, controller 20 may end algorithm 50 (e.g., return to “start” in FIG. 2A).

When controller 20 determines that the status of second starter 16b is “unavailable” or “failed” upon completion of step 76, controller 20 may generate, log, and/or report faults and/or alert the machine operator with respect to both first starter 16a and second starter 16b (step 84). For example, controller 20 may cause interface 18 to display: “The primary starter has overheated, and the secondary starter has failed. Maintenance is required. Please wait 15 minutes and try the primary starter again.”

When controller 20 determines that second starter 16b is selected upon completion of step 70, controller 20 may determine if the status of second starter 16b is “ready” (step 86). If so, controller 20 may initiate cranking of engine 14 with second starter 16b (step 88). If controller 20 determines upon completion of step 86 that the status of second starter 16b is “unavailable” or “failed”, controller 20 may determine if the status of first starter 16a is “ready” (step 90). If so, controller 20 may then generate, log, and/or report a fault and/or alert the machine operator with respect to second starter 16b (step 92), and prompt the operator by way of interface 18 to start engine 14 with first starter 16a instead of second starter 16b (step 94). For example, controller 20 may cause interface 18 to display: “The secondary starter has failed. Start engine with primary starter (Yes/No)?” If the operator chooses “Yes”, controller 20 may initiate cranking of engine 14 with first starter 16a (step 96). If the operator chooses “No” during step 94, controller may end algorithm 50 (e.g., return to “start” in FIG. 2A).

When controller 20 determines that the status of first starter 16a is “unavailable” or “failed” upon completion of step 90, controller 20 may generate, log, and/or report a fault and/or alert the machine operator with respect to both of starters 16a and 16b (step 98). For example, controller 20 may cause interface 18 to display: “The primary starter is unavailable due to overheating. Please wait 15 minutes and try the primary starter again. The secondary starter has failed. Maintenance is required.”

By employing the disclosed starter control system, failure and/or the unavailability of either or both starters may be detected and reported prior to initiating a starting event. Further, in the event of failure of one of the starters, a full-capacity back up starter may be available to independently effect cranking of the engine to a speed necessary for ignition. Also, since the starters may operate independently (i.e., not in tandem), the integrity of a backup starter may be preserved.

It will be apparent to those skilled in the art that various modifications and variations can be made to the disclosed starter control system and/or algorithm. For example, if the controller determines that the battery for the first starter is low (i.e., “unavailable”), and the second starter has failed, controller 20 may be able to initiate engine cranking with the first starter using the battery of the second starter (e.g., toggle a switch directing the flow of current to the first starter). Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A starter control system for a combustion engine, comprising:
a first starter and a second starter each coupled to independently initiate cranking of the combustion engine;
a sensor to generate a first signal indicative of an operational condition; and
a controller communicatively coupled to the first and second starters and the sensor, the controller being configured to:
determine a status of the first starter and a status of the second starter based on the first signal; and
command one of the first and second starters to crank the combustion engine to an ignition speed based the status of the first starter and the status of the second starter in response to a request to start the combustion engine.

2. The starter control system of claim 1, wherein:
the controller is further configured to receive a selection signal indicative of which of the first and second starters is desired by an operator for use during a cranking event; and
the controller commands the one of the first and second starters to crank the combustion engine based further on the selection signal.

3. The starter control system of claim 1, wherein commanding includes autonomously selecting an available one of the first and second starters to crank the combustion engine.

4. The starter control system of claim 1, wherein the status of the first and second starters each includes one of a failed state, an unavailable state, and a ready state.

5. The starter control system of claim 1, wherein the first and second starters each comprise at least one battery operatively coupled to energize at least one motor/generator.

6. The starter control system of claim 5, wherein the combustion engine is coupled to drive the at least one motor/generator to charge the at least one battery during operation.

7. The starter control system of claim 1, wherein the first and second starters each comprise at least one battery operatively coupled to energize at least one motor.

8. A starter control system for a combustion engine, comprising:
a first starter and a second starter each coupled to independently initiate cranking of the combustion engine; and
a controller communicatively coupled to the first and second starters and being configured to:
receive a request signal indicative of an operator's desire to start the combustion engine;
receive a selection signal indicative an operator desired one of the first and second starters to start the combustion engine; and
command one of the first and second starters to crank the combustion engine to an ignition speed based on the selection signal and in response to the request signal.

9. The starter control system of claim 8, wherein the controller is further configured to:
alert an operator when the desired one of the first and second starters cannot be used; and
prompt the operator to start the combustion engine with the other of the first and second starters.

10. The starter control system of claim 8, wherein the status of the first and second starters each includes one of a failed state, an unavailable state, and a ready state.

11. The starter control system of claim 8, wherein the first and second starters each comprise at least one battery coupled to energize at least one motor/generator.

12. The starter control system of claim 11, wherein the combustion engine is coupled to drive the at least one motor/generator to charge the at least one battery during operation.

13. The starter control system of claim 8, wherein the first and second starters each comprise at least one battery coupled to energize at least one motor.

14. A machine, comprising:
a combustion engine configured to power operations of the machine;
a first starter and a second starter each coupled to independently initiate cranking of the combustion engine;
an interface configured to receive input from a machine operator;
a sensor to generate a first signal indicative of an operational condition of the machine; and
a controller communicatively coupled to the first starter, the second starter, the interface, and the sensor, the controller being configured to:
receive a request signal indicative of the operator's desire to start the combustion engine;
determine a status of the first starter and a status of the second starter based on the first signal; and
command one of the first and second starters to crank the combustion engine to an ignition speed based the status of the first starter and the status of the second starter in response to the request signal.

15. The machine of claim 14, wherein:
the controller is further configured to receive a selection signal indicative of which of the first and second starters is desired by an operator for use during a cranking event; and
the controller commands the one of the first and second starters to crank the combustion engine based further on the selection signal.

16. The machine of claim 14, wherein commanding includes autonomously selecting an available one of the first and second starters to crank the combustion engine.

17. The machine of claim 14, wherein the status of the first and second starters each includes one of a failed state, an unavailable state, and a ready state.

18. The machine of claim 14, wherein the first and second starters each comprise at least one battery operatively coupled to energize at least one motor/generator.

19. The machine of claim 18, wherein the combustion engine is coupled to drive the at least one motor/generator to charge the at least one battery during operation.

20. The machine of claim 14, wherein the first and second starters each comprise at least one battery operatively coupled to energize at least one motor.
